(19) United States
(12) Patent Application Publication
(10) Pub. No.: US 2003/0223015 A1
(43) Pub. Date: Dec. 4, 2003

(54) Signal mixing circuit

(76) Inventor: Yukio Tsubokawa, Takefu-City (JP)

Correspondence Address: WENDEROTH, LIND & PONACK, L.L.P., 2033 K STREET N. W., SUITE 800, WASHINGTON, DC, 20006-1021, US

(21) Appl. No.: 10/410,403

(22) Filed: Apr. 10, 2003

(30) Foreign Application Priority Data
Apr. 11, 2002 (JP) 2002-109073

(51) Int. Cl. H04N 9/74

(52) U.S. Cl. 348/584; 348/511; 348/722

(57) ABSTRACT

A signal mixing circuit for mixing synchronizing signals and video signals without attenuating these signals, comprising a first semiconductor device for inputting and outputting synchronizing signals and a second semiconductor device for inputting and outputting video signals, wherein said first and second semiconductor devices operate as a buffer amplifier of input signals and said synchronizing signals and video signals are mixed after passing said first and second semiconductor devices respectively.

### BACKGROUND OF THE INVENTION

The present invention relates to a signal mixing circuit for mixing synchronizing signals with video signals.

When displaying video pictures on a monitor such as a television receiver, video signals having video information and synchronizing signals to synchronize operation of a monitor are input into a monitor. A signal mixing circuit is used to mix synchronizing signals output from a synchronizing signal source with video signals output from a video signal source and to input the mixed signals into a monitor.

Such a signal mixing circuit occasionally attenuates signals of one circuit influenced by another circuit by an interaction of two circuits to be connected to a mixing point.

In case synchronizing signals are attenuated, synchronizing operation cannot be attained in a monitor, and as a result, distorted video pictures are displayed on a monitor.

### SUMMARY OF THE INVENTION

It is, therefore, an object of the present invention to provide a signal mixing circuit which can mix synchronizing signals with video signals and output these signals without attenuating.

In order to solve the above problems, the present invention provides a signal mixing circuit comprising a first semiconductor device having a first signal input terminal and a first signal output terminal outputting synchronizing signals input from the first signal input terminal and a second semiconductor device having a second signal input terminal and a second signal output terminal outputting video signals input from the second signal input terminal to mix the synchronizing signals output from the first semiconductor device with the video signals output from the second semiconductor device, wherein the first semiconductor device and the second semiconductor device are connected in the circuit so as to operate as a buffer amplifier of input signals.

When mixing synchronizing signals with video signals, synchronizing signals are passed through the first semiconductor device which operates as a buffer amplifier and video signals are passed through the second semiconductor device which operates as a buffer amplifier, thereby these signals being mixed.

As a result, a video signal circuit does not affect the output of synchronizing signals and a synchronizing signal circuit does not affect the output of video signals. Thus, synchronizing signals and video signals can be mixed without being attenuated. Accordingly, a monitor can display stabilized video pictures without causing distortion of synchronizing operation of monitor.

The first signal output terminal can be connected with a gain adjustment means in order to mix synchronizing signals output from the first signal output terminal with video signals after a gain is added to synchronizing signals by the gain adjustment means. With such an arrangement, enhanced synchronizing signals are mixed with video signals, so that the operation for displaying video pictures on a monitor can be more stabilized.

Each of the first semiconductor device and the second semiconductor device can be constituted by a transistor and a base terminal of the respective transistor is used for a signal input terminal, so that the transistors operate as a buffer amplifier respectively.

A signal mixing circuit comprising a first semiconductor device and a second semiconductor device constituted by a transistor can be constructed easily and with low manufacturing costs.

### BRIEF DESCRIPTION OF THE DRAWINGS

FIG. 1 is a circuit diagram showing one embodiment of a signal mixing circuit according to the present invention;

FIG. 2 is a circuit diagram showing a comparative example compared with the present invention; and

FIG. 3 is a block diagram showing a digital video apparatus, to which the signal mixing circuit according to the present invention is applied.

### DETAILED DESCRIPTION OF THE PREFERRED EMBODIMENTS

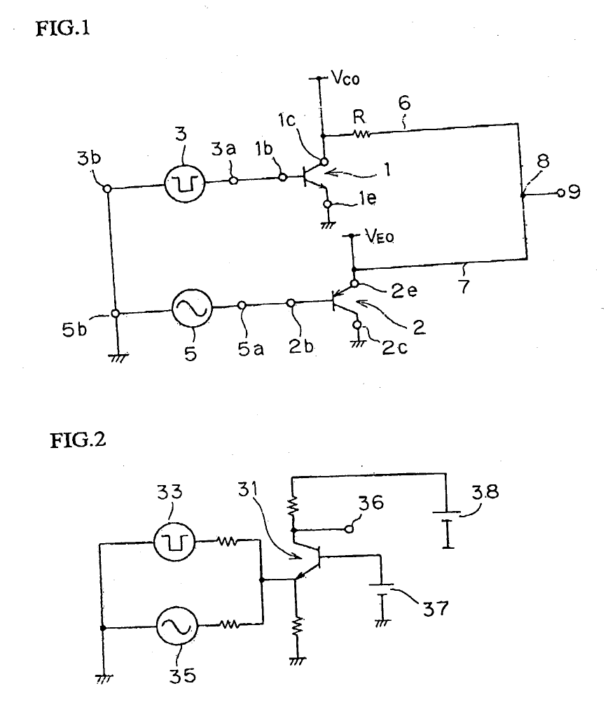

Hereunder, the present invention will now be described with reference to the attached drawings. FIG. 1 is a circuit diagram showing one embodiment of a signal mixing circuit according to the present invention. In FIG. 1, numeral 1 denotes a first transistor; 2 denotes a second transistor; 3 denotes a signal source for synchronizing signals; and 5 denotes signal source for video signals.

A first transistor 1 is provided with a base terminal 1b, a collector terminal 1c, and an emitter terminal 1e. The base terminal 1b is connected with one terminal 3a of a signal source 3 for synchronizing signals to input synchronizing signals. The other terminal 3b of the signal source 3 for synchronizing signals is grounded.

To the collector terminal 1c, an operating voltage V_{CO} is impressed to operate the transistor 1. An electric potential is formed at the collector terminal 1c in response to synchronizing signals input to the base terminal 1b, thereby forming output signals for synchronizing signals. The emitter terminal 1e of the transistor 1 is grounded.

As shown in FIG. 1, the first transistor 1 is connected so as to receive input signals via the base terminal 1b and output output signals via the collector terminal 1c, so that the first transistor 1 operates as a buffer amplifier of input signals.

The first transistor 1 amplifies electric current suitably depending on the impedance of both on the output side and the input side of the transistor 1, and the transistor 1 operates in such a manner that the voltage gain of output signals of the collector terminal 1c to input signals of the base terminal 1b is approximately 1.

The first transistor 1 corresponds to a first semiconductor device, the base terminal 1b corresponds to a first signal input terminal for inputting synchronizing signals, and the collector terminal 1c corresponds to a first signal output terminal for outputting synchronizing signals. An input resistor, although not shown, may be connected between the base terminal 1b of the first transistor 1 and the signal source 3.

One end of a first signal transmission line 6 is connected with the collector terminal 1c of the transistor 1, and the other end of the first signal transmission line 6 is connected with a signal mixing point 8, whereby synchronizing signals output from the collector terminal 1c are transmitted to the signal mixing point 8. A resistor R is serially connected to the first signal transmission line 6. The electric potential of the synchronizing signals output from the collector terminal 1c is enhanced in response to a resistance value of the resistor R.

The resistor R corresponds to a gain adjustment means for adding a gain to synchronizing signals. The resistor R may be a resistive element having a fixed resistance value or a variable resistive element whose resistance value can be adjusted to a given value. The resistor R is not necessarily required. However, it is preferable to connect the resistor R for adding a gain to synchronizing signals in order to detect the synchronizing signals without fail.

A second transistor 2 is provided with a base terminal 2b, a collector terminal 2c, and an emitter terminal 2e. The base terminal 2b is connected with one terminal 5a of a signal source 5 for video signals to input video signals. The other terminal 5b of the signal source 5 for video signals is grounded.

To the emitter terminal 2e, an operating voltage V_{EO} is impressed to operate the transistor 2. An electrical potential is formed at the emitter terminal 2e in response to video signals input to the base terminal 2b, thereby forming output signals for video signals. The collector terminal 2c of the transistor 2 is grounded.

The second transistor 2 is connected, as shown in FIG. 1, so as to receive input signals via the base terminal 2b and output output signals via the emitter terminal 2e, so that the second transistor 2 operates as a buffer amplifier of input signals.

The second transistor 2 amplifies electric current suitably depending on the impedance of both on the output side and the input side of the transistor 2, and the transistor 2 operates in such a manner that the voltage gain of output signals of the emitter terminal 2e to input signals of the base terminal 2b is approximately 1.

The second transistor 2 corresponds to a second semiconductor device, the base terminal 2b corresponds to a second signal input terminal for inputting video signals, and the emitter terminal 2e corresponds to a second signal output terminal for outputting video signals. An input resistor, although not shown, may be connected between the base terminal 2b of the second transistor 2 and the signal source 5.

One end of a second signal transmission line 7 is connected with the emitter terminal 2e of the second transistor 2, and the other end of the second signal transmission line 7 is connected with a signal mixing point 8, whereby synchronizing signals output from the emitter terminal 2e are transmitted to the signal mixing point 8.

Signals transmitted to the signal mixing point 8, where the first signal transmission line 6 and the second signal transmission line 7 are connected, are output via a mixed signal output terminal 9. Thus, synchronizing signals transmitted through the first signal transmission line 6 to the signal mixing point 8 and video signals transmitted through the second signal transmission line 7 to the signal mixing point 8 are mixed at the signal mixing point 8 and thereafter output via the mixed signal output terminal 9.

According to the signal mixing circuit in the present invention, as explained heretofore, synchronizing signals output from the signal source 3 pass through the first transistor 1, and video signals output from the signal source 5 pass through the second transistor 2. And these signals are mixed at the signal mixing point 8. Finally, signals mixed at the signal mixing point 8 are output from the mixed signal output terminal 9.

In the signal mixing circuit according to the present invention, the first transistor 1 and the second transistor 2 are, as already explained, connected so as to operate as a buffer amplifier respectively. Since both of synchronizing signals and video signals are mixed after passing through the respective buffer amplifiers, signals of one line are not affected by the other line. In other words, a circuit of the signal source 5 does not affect an output of synchronizing signals, and a circuit of the signal source 3 does not affect an output of video signals. Thus, the synchronizing signals and the video signals can be mixed without attenuation.

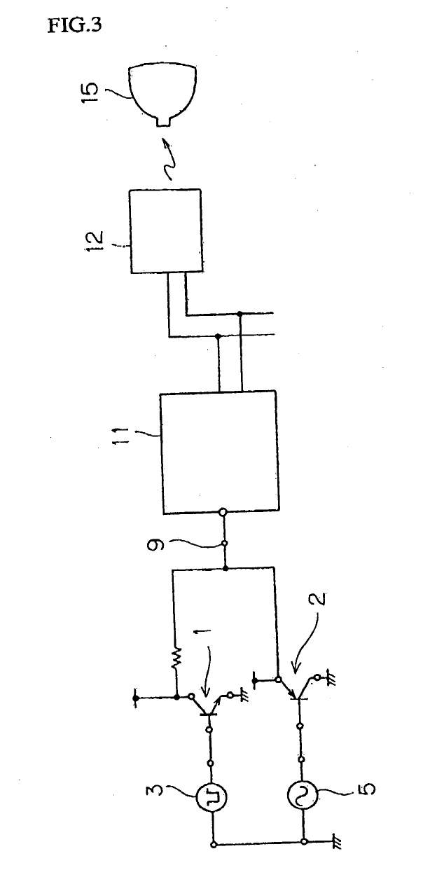

FIG. 2 is a circuit diagram showing one comparative example of a signal mixing circuit that is not in accordance with the present invention. In FIG. 2, 31 denotes a transistor; 33 denotes a signal source for synchronizing signals; 35 denotes a signal source for video signals; and 36 denotes an output terminal of signals.

According to a signal mixing circuit shown in FIG. 2, synchronizing signals output from the signal source 33 and video signals output from the signal source 35 are mixed before inputting to the transistor 31. The mixed signals of synchronizing signals and video signals are input via an emitter terminal to the transistor 31 and output via a collector terminal of the transistor 31 to the output terminal 36.

As a circuit of the signal source 33 and a circuit of the signal source 35 are connected in parallel to the emitter terminal of the transistor, synchronizing signals input from the signal source 33 to the emitter terminal of the transistor 31 is attenuated by the circuit of the signal source 35. As a result, synchronizing signals output via the transistor 31 from the output terminal 36 are also attenuated.

Further, according to the circuit as shown in FIG. 2, an electric source 37 to operate the transistor 31 is required, and besides an electric source 38 to ensure a fixed value for output signals is necessitated.

On the other hand, according to the signal mixing circuit in the present invention, as already explained heretofore, both of synchronizing signals and video signals are mixed after passing through the transistors 1 and 2 operating as buffer amplifiers respectively. Consequently, a circuit of the signal source 5 does not affect output of synchronizing signals, and a circuit of the signal source 3 does not affect output of video signals Thus, both of synchronizing signals and video signals can be output from a signal mixing circuit without attenuation.

Also, both of synchronizing signals and video signals are not attenuated, so that an electric source for ensuring a fixed value for output signals is not required. Only an electric source impressing a voltage V_{CO} to the transistor 1 and an electric source impressing a voltage V_{EO} to the transistor 2 are required. Thus, electric sources for operation can be simplified.

The signal mixing circuit according to the present invention can be applied to digital video apparatuses. FIG. 3 is a block diagram in relation to a digital video apparatus employing the signal mixing circuit of the present invention.

The digital video apparatus shown in FIG. 3 is provided with a signal mixing circuit according to the present invention, and the signal mixing circuit is connected with a microcomputer 11 which controls a video signal control means 12, thereby controlling the operation of a monitor 15.

The microcomputer 11 is provided with a memory section and an operation section, although not shown, that can process synchronizing signals and video signals input from the mixed signal output terminal 9. The microcomputer 11 and the video signal control means 12 are connected with each other via a bus line for data communication, e.g., I²C bus. The video signal control means 12 may be constituted by a video signal processing IC, e.g., a chroma IC.

Synchronizing signals and video signals mixed together by the signal mixing circuit according to the present invention are output from the mixed signal output terminal 9 and input to the microcomputer 11.

The microcomputer 11 determines the presence of video signals, for example, by counting a pulse number of synchronizing signals. And after processing synchronizing signals and video signals by the microcomputer 11, the video signal control means 12 is controlled. Thereafter, the video signal control means 12 controls the operation of the monitor 15 to display video pictures on the monitor in response to the video signals. Synchronizing signals attain the synchronizing operation of the monitor 15.

In the digital video apparatus as shown in FIG. 3, as synchronizing signals and video signals are prevented from being attenuated by a signal mixing circuit according to the present invention, the microcomputer 11 can precisely determine and process synchronizing signals and video signals. Thus, the microcomputer 11 can control the monitor 15 to display stabilized video pictures.

In case the microcomputer 11 determines the presence of video signals by counting a pulse number of synchronizing signal, since the signal mixing circuit can prevent synchronizing signals from being attenuated, video signals can be determined without fail, so that the monitor 15 can display stabilized video pictures.

Heretofore, explanations are made on the basis that the first transistor 1 is a NPN transistor and the second transistor 2 is a PNP transistor. However, each of the transistor 1 and the transistor 2 may be either a NPN transistor or a PNP transistor. Further, both of the transistor 1 and the transistor 2 may be either a NPN transistor or a PNP transistor. Namely, the transistor 1 and the transistor 2 are only required respectively to operate as a buffer amplifier of signals input from a base terminal of a signal input terminal.

Likewise, the above-described explanations are made using the transistor 1 as a first semiconductor 1 and the transistor 2 as a second semiconductor, however, these transistors can be replaced with another semiconductors such as a FET (field-effect transistor). Namely, the first semiconductor and the second semiconductor are only required respectively to operate as a buffer amplifier of signals input from a signal input terminal and to output the signals from a signal output terminal.

As explained heretofore, the signal mixing circuit according to the present invention can mix synchronizing signals and video signals without attenuation, and as a result, the mixed synchronizing signals and video signals can control the operation of a monitor without fail, so that the monitor can display video pictures in a stable manner.

What is claimed is:

1. A signal mixing circuit comprising: a first semiconductor device having a first signal input terminal and a first signal output terminal outputting synchronizing signals input from said first signal input terminal and a second semiconductor device having a second signal input terminal and a second signal output terminal outputting video signals input from said second signal input terminal to mix said synchronizing signals output from said first semiconductor device with said video signals output from said second semiconductor device, wherein said first semiconductor device and said second semiconductor device are connected in the circuit so as to operate as a buffer amplifier of input signals.

2. A signal mixing circuit claimed in claim 1, wherein said first signal output terminal is connected with a gain adjustment means to mix synchronizing signals output from said first signal output terminal with video signals after a gain is added to synchronizing signals by said gain adjustment means.

3. A signal mixing circuit claimed in claim 1, wherein each of said first semiconductor device and said second semiconductor device is a transistor and each of a base terminal of said respective transistor is used for a signal input terminal.

4. A signal mixing circuit claimed in claim 2, wherein each of said first semiconductor device and said second semiconductor device is a transistor and each of a base terminal of said respective transistor is used for a signal input terminal.
